(19) United States
(12) Patent Application Publication
(10) Pub. No.: US 2023/0158911 A1
(43) Pub. Date: May 25, 2023

(54) PARKING ASSIST APPARATUS

(71) Applicant: TOYOTA JIDOSHA KABUSHIKI KAISHA, Toyota-shi (JP)

(72) Inventor: YU HIEI, Chiryu-shi (JP)

(73) Assignee: TOYOTA JIDOSHA KABUSHIKI KAISHA, Toyota-shi (JP)

(21) Appl. No.: 17/981,908

(22) Filed: Nov. 7, 2022

(30) Foreign Application Priority Data
Nov. 22, 2021 (JP) 2021-189176

(51) Int. Cl. B60L 53/37; B60L 53/12; H02J 50/10

(52) U.S. Cl. CPC B60L 53/37; B60L 53/12; H02J 50/10; B60L 53/36

(57) ABSTRACT

A parking assist apparatus includes: a wireless communication device capable of wireless communication to and from a wireless power supply device; a power receiving unit which receives transmission of power from a power transmission unit in a non-contact manner; and a vehicle control ECU which acquires information indicating a manufacturer of the wireless power supply device from the wireless power supply device by the wireless communication, identifies a position of the power transmission unit from feature information corresponding to the manufacturer indicated by the acquired information and an image of a periphery of a vehicle, sets a position of a target parking area so that a position of the power receiving unit matches the position of the power transmission unit, and automatically moves the vehicle to the set target parking area.

### BACKGROUND OF THE INVENTION

### 1. Field of the Invention

The present invention relates to a parking assist apparatus capable of charging a vehicle battery by receiving power from power supply equipment arranged externally to a vehicle.

### 2. Description of the Related Art

Hitherto, there has been known a parking assist apparatus which photographs a road surface around a vehicle by using a camera mounted on the vehicle, detects positions of a parking space and a power transmission unit installed in the parking space by performing image processing on the taken images, and moves the vehicle based on results of the detection so that a position of a power receiving unit of the vehicle and the position of the power transmission unit of the parking space match (so that deviation is reduced).

The parking assist apparatus as disclosed in Japanese Patent Application Laid-open No. 2017-138664 is configured to photograph the parking space and a road surface in the vicinity of the parking space by using a camera mounted on the vehicle, and detect a target parking position by converting coordinates (coordinates of pixels) in the image of an image of the power transmission unit included in the taken images to coordinates in real space. Further, the parking assist apparatus as disclosed in WO 2011/132271 A1 is configured to photograph a light emitting portion arranged in a power transmission unit by using a camera, detect the position and orientation of the light emitting portion by using image recognition, detect a positional relationship between the power transmission unit and the vehicle based on results of the detection, and guide the vehicle to the power transmission unit by controlling the steering of the vehicle based on a result of the detection of the positional relationship between the power transmission unit and the vehicle.

However, in the related-art method of identifying the position of the power transmission unit from an image taken by the camera, the external appearance shape of the power transmission unit is unknown, and hence there may be cases in which the power transmission unit or the position of the power transmission unit is not identifiable from the taken image. When the position of the power transmission unit is not accurately identifiable, it is not possible to align each of the position of the power transmission unit and the position of the power receiving unit of the vehicle with a position suitable for charging. This may consequently cause a decrease in charging efficiency or improper charging when power is wirelessly supplied in the parking space.

### SUMMARY OF THE INVENTION

The present invention has been made in order to address the above-mentioned problem. That is, one object of the present invention is to provide a parking assist apparatus capable of parking a vehicle at a position suitable for charging with respect to a power transmission unit.

According to at least one embodiment of the present invention, there is provided a parking assist apparatus (20), the parking assist apparatus (20) being mounted on a vehicle (10) including a power receiving unit (224) configured to receive power from a power supply device (90) including a power transmission unit (92), the parking assist apparatus (20) being configured to execute parking assist for parking the vehicle (10) in a parking space, the parking assist apparatus (20) including: a wireless communication device (223) configured to perform wireless communication to and from the power supply device (90); an image pickup device (210, 211, 212, 213) configured to photograph a peripheral region of the vehicle (10); and a control device (201) configured to search for a parking space (PS) present in the peripheral region of the vehicle (10) from an image of the peripheral region of the vehicle (10) taken by the image pickup device (210, 211, 212, 213), set a target parking area (TA) in the parking space (PS) detected by the search, and assist parking of the vehicle (10) in the target parking area (TA). The control device (201) has external appearance information, which is information relating to a feature of an external appearance of each of a plurality of the power transmission units (92), registered therein in association with identification information on the power supply device (90). The control device (201) is configured to, when the control device (201) sets the target parking area (TA) in the detected parking space (PS): acquire the identification information transmitted from the power supply device (90) installed in the parking space via the wireless communication device (223); search for the power transmission unit (92) included in the image of the peripheral region of the vehicle (10) by using the external appearance information corresponding to the acquired identification information; identify a position of the power transmission unit (92) detected by the search; and set a position of the target parking area (TA) so that a position of the power receiving unit (224) matches the position of the power transmission unit (92) in a top view.

According to the at least one embodiment of the present invention, the external appearance information corresponding to the identification information on the power supply device is used to search for the power transmission unit. With this configuration, it is possible to search for the power transmission unit which matches the external appearance information. Further, the position of the power transmission unit detected by the search can be accurately identified. Therefore, by setting the position of the target parking area so that the identified position of the power transmission unit and the position of the power receiving unit of the vehicle match in a top view, the target parking area can be set at a position suitable for charging. As a result, the vehicle can be parked in a position suitable for charging with respect to the power transmission unit. Moreover, according to the at least one embodiment of the present invention, it is possible to reduce the processing load on the control device. For example, with a method in which pieces of external appearance information on various power transmission units are registered in advance in the control device, and the power transmission unit is searched for in an exhaustive manner by using those plurality of pieces of external appearance information, processing of “searching for the power transmission unit by using a piece of external appearance information” is required to be executed repeatedly for each piece of external appearance information. In contrast, according to the at least one embodiment of the present invention, through use of the external appearance information corresponding to the identification information acquired by wireless communication, the power transmission unit can be searched for by using only the external appearance information indicated by the acquired identification information, and it is not required to perform an exhaustive search. Consequently, the processing load on the control device is reduced as compared with the method of searching for the power transmission unit in an exhaustive manner by using a plurality of pieces of external appearance information.

In one aspect of the present invention, the identification information is information indicating a manufacturer of the power supply device.

With the above-mentioned configuration, even when the external shape (external appearance) of the power transmission unit is different for each manufacturer, the power transmission unit can be searched for and the position of the power transmission unit can be identified.

In one aspect of the present invention, the power receiving unit (224) includes a power receiving coil (225) configured to receive supply of power in a non-contact manner from the power transmission unit (92) including a power transmission coil (93).

In the method of transmitting power from the power transmission unit to the power receiving unit in a non-contact manner, when the misalignment between the power transmission coil of the power transmission unit and the power receiving coil of the power receiving unit becomes smaller, the efficiency of power transmission becomes higher. Therefore, with the above-mentioned configuration, the efficiency of power transmission from the power transmission unit of the power supply device to the power receiving unit of the vehicle can be increased.

In the above description, the terms and/or reference symbols used in at least one embodiment described later are enclosed in parentheses and assigned to the components of the present invention corresponding to the at least one embodiment for easier understanding of the present invention. However, the constituent elements of the present invention are not limited to the at least one embodiment defined by the terms and/or reference symbols.

### BRIEF DESCRIPTION OF THE DRAWINGS

FIG. 1 is a diagram for illustrating a parking assist apparatus according to at least one embodiment of the present invention.

FIG. 2A is a diagram for illustrating a positional relationship between a parking space and a target parking area.

FIG. 2B is a diagram for illustrating a positional relationship between a parking space and a target parking area.

FIG. 3A is a flowchart for illustrating a parking assist routine to be executed by a CPU.

FIG. 3B is a flowchart for illustrating a parking assist routine to be executed by the CPU.

### DESCRIPTION OF THE EMBODIMENTS

At least one embodiment of the present invention is now described. In the following description, a parking assist apparatus for a vehicle may be abbreviated as “assist apparatus.” Further, “parking space” in the following description means a space partitioned so that one vehicle can park.

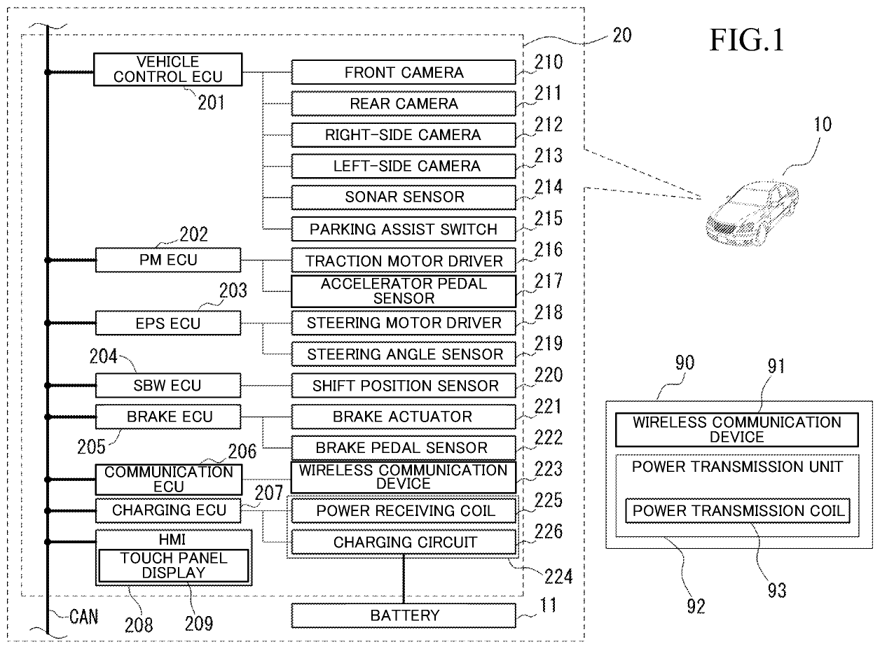

FIG. 1 is a schematic diagram for illustrating a configuration example of a vehicle 10, an assist apparatus 20 mounted on the vehicle 10, and a wireless power supply device 90 that can transmit power (can transmit electrical power) to the vehicle 10 in a non-contact manner. The vehicle 10 in the at least one embodiment is an electric vehicle (electric automobile), which includes a traction motor (not shown) and a battery 11. The traction motor is a driving force source for traveling. The battery 11 is a power source for in-vehicle devices including the traction motor. The assist apparatus 20 is configured such that power can be received (transmission of electrical power can be received) from the wireless power supply device 90 installed in a parking space PS in a non-contact manner to charge the battery 11.

The wireless power supply device 90 is configured to transmit power to the assist apparatus 20 in a non-contact manner. The wireless power supply device 90 includes a power transmission unit 92 including a power transmission coil 93, and a wireless communication device 91 capable of wireless communication to and from a wireless communication device 223 mounted on the vehicle 10. To distinguish between the wireless communication device 223 and the wireless communication device 91, the wireless communication device 223 mounted on the vehicle 10 is hereinafter referred to as “in-vehicle communication device 223,” and the wireless communication device 91 of the wireless power supply device 90 installed in the parking space PS is referred to as “equipment communication device 91.” The power transmission unit 92 is installed at a predetermined position on a road surface of the parking space PS so that the power transmission unit 92 is located at a lower position than the vehicle 10 when the vehicle 10 is parked in the parking space PS. The configuration of the wireless power supply device 90 is not particularly limited, and a configuration publicly known in the related art can be applied.

As illustrated in FIG. 1, the assist apparatus 20 includes a vehicle control ECU 201, a power management ECU (hereinafter referred to as “PM ECU 202”), an electric power steering ECU (hereinafter referred to as “EPS ECU 203”), a shift-by-wire ECU (hereinafter referred to as “SBW ECU 204”), a brake ECU 205, a communication ECU 206, a charging ECU 207, and a human machine interface (HMI) 208. Each ECU includes a microcomputer. The microcomputer includes, for example, a CPU, a ROM, a RAM, a readable and writable non-volatile memory, and an interface. The CPU implements various functions by executing instructions (programs and routines) stored in the ROM. The ECUs and the HMI 208 are connected to each other so that data is exchangeable (communicable) via a controller area network (CAN). Therefore, detection results obtained by sensors connected to a certain ECU and operations to switches, for example, can be acquired by an ECU other than the certain ECU.

The vehicle control ECU 201 is a central electronic control unit which assists the driver with parking. The vehicle control ECU 201 is an example of a control device in the present invention, and executes parking assist control described later. A plurality of cameras 210, 211, 212, and 213, a plurality of sonar sensors 214, and a parking assist switch 215 are connected to the vehicle control ECU 201. In FIG. 1, one sonar sensor 214 is illustrated for simplification.

The plurality of cameras 210, 211, 212, and 213 are an example of an image pickup device in the present invention. The plurality of cameras 210, 211, 212, and 213 generate image data by photographing the landscape of the region around the vehicle 10 (the landscape outside the vehicle). The plurality of cameras 210, 211, 212, and 213 include a front camera 210, a rear camera 211, a right-side camera 212, and a left-side camera 213. The front camera 210 is arranged, for example, in a substantially central portion of a front bumper in a vehicle width direction, and generates image data by photographing a landscape including the road surface in front of the vehicle 10. The rear camera 211 is arranged, for example, on a wall portion of a rear trunk at the rear of the vehicle 10, and generates image data by photographing a landscape including the road surface behind the vehicle 10. The right-side camera 212 is arranged, for example, on a right side-view mirror, and generates image data by photographing a landscape including the road surface on the right side of the vehicle 10. The left-side camera 213 is arranged, for example, on a left side-view mirror, and generates image data by photographing a landscape including the road surface on the left side of the vehicle 10. Each of the cameras 210, 211, 212, and 213 continuously transmits the generated image data to the vehicle control ECU 201.

Each sonar sensor 214 is a well-known sensor which uses ultrasonic waves. Each sonar sensor 214 emits ultrasonic waves in a predetermined range around the vehicle 10 and receives reflected waves reflected by an object. Each sonar sensor 214 detects the presence or absence of a three-dimensional object and the distance to the three-dimensional object based on a period of time from the transmission to the reception of the ultrasonic waves, and continuously transmits the detection result to the vehicle control ECU 201.

The parking assist switch 215 is a switch which can be operated by an occupant of the vehicle 10 (user of the vehicle 10). The parking assist switch 215 is arranged at a position at which the occupant (driver) sitting in a driver's seat of the vehicle 10 can operate the parking assist switch 215. The vehicle control ECU 201 can detect an operation on the parking assist switch 215.

In addition, a vehicle speed sensor (not shown) is connected to the vehicle control ECU 201. The vehicle speed sensor detects the vehicle speed, and continuously outputs a signal indicating the detected vehicle speed to the vehicle control ECU 201.

The PM ECU 202 is an electronic control unit for controlling a driving force generated by the traction motor. A traction motor driver 216 and an accelerator pedal sensor 217 are connected to the PM ECU 202. The traction motor driver 216 drives the traction motor. The traction motor driver 216 is, for example, an inverter. The accelerator pedal sensor 217 detects an operation amount of an accelerator pedal (not shown), and transmits the detection result to the PM ECU 202. The PM ECU 202 sets a target driving force in accordance with the operation amount of the accelerator pedal detected by the accelerator pedal sensor 217, and controls the traction motor driver 216 so that the target driving force is generated.

The vehicle control ECU 201 can transmit a drive command (a signal for controlling the driving force, for example, a signal indicating a target travel speed) to the PM ECU 202. When the PM ECU 202 receives the drive command from the vehicle control ECU 201, the PM ECU 202 controls the traction motor driver 216 so that the vehicle 10 travels at the travel speed indicated by the drive command. Therefore, the PM ECU 202 can automatically drive the traction motor (that is, without requiring the driver to operate the accelerator pedal) in accordance with the drive command received from the vehicle control ECU 201.

The EPS ECU 203 is an electronic control unit of a well-known electric power steering system. The EPS ECU 203 is connected to a steering motor driver 218 and a steering angle sensor 219. The steering motor driver 218 can change a steering angle (also referred to as “steered angle” or “steer angle”) of the vehicle 10 by controlling a steering motor (not shown). The steering angle sensor 219 is configured to detect the steering angle of a steering wheel of the vehicle 10, and output a signal indicating the steering angle. The EPS ECU 203 applies a steering torque (steering assist torque) to a steering mechanism (not shown) by controlling the steering motor driver 218 based on the signal output from the steering angle sensor 219 and the vehicle speed and driving the steering motor, thereby assisting the steering operation by the driver.

The vehicle control ECU 201 can transmit a steering command (a signal for controlling the steering angle of the vehicle 10, for example, a signal including a target steering angle) to the EPS ECU 203. When the EPS ECU 203 receives the steering command from the vehicle control ECU 201, the EPS ECU 203 controls the steering motor driver 218 in accordance with the received steering command. Therefore, the vehicle control ECU 201 can automatically change the steering angle of steered wheels of the vehicle 10 (that is, without requiring a steering operation by the driver) via the EPS ECU 203.

The SBW ECU 204 is connected to a shift position sensor 220. The shift position sensor 220 detects a position of a shift lever, which is an operating member that can be operated by the driver. The positions of the shift lever include a parking position (P), a forward drive position (D), and a reverse position (R). The SBW ECU 204 receives the position of the shift lever from the shift position sensor 220, and switches a shift range of a transmission (not shown) of the vehicle 10 based on the position (that is, performs shift control of the vehicle 10).

The vehicle control ECU 201 can transmit a shift change command (a signal for switching the shift range of the transmission, for example, a signal including the shift range after switching) to the SBW ECU 204. When the SBW ECU 204 receives the shift change command from the vehicle control ECU 201, the SBW ECU 204 performs control to switch the shift range of the transmission in accordance with the received shift change command. Therefore, the vehicle control ECU 201 can automatically change the shift range of the transmission of the vehicle 10 (that is, without requiring the driver to operate the shift lever) via the SBW ECU 204.

The brake ECU 205 is connected to a brake actuator 221 and a brake pedal sensor 222. The brake pedal sensor 222 is configured to detect an operation amount of a brake pedal (not shown). The brake ECU 205 applies to the wheels a braking force in accordance with the operation amount of the brake pedal by operating the brake actuator 221 in accordance with the detection result of the operation amount of the brake pedal acquired from the brake pedal sensor 222.

The vehicle control ECU 201 can transmit a braking command (a signal for controlling the braking force, for example, a signal including a target braking force) to the brake ECU 205. When the brake ECU 205 receives the braking command from the vehicle control ECU 201, the brake ECU 205 controls the brake actuator 221 in accordance with the received braking command. Therefore, the brake ECU 205 can automatically control the braking force of the vehicle 10 (that is, without requiring the driver to operate the brake pedal) by controlling the brake actuator 221.

The in-vehicle communication device 223 (wireless communication device) is connected to the communication ECU 206. The in-vehicle communication device 223 can perform wireless communication to and from the wireless communication device (equipment communication device 91) of the wireless power supply device 90. The in-vehicle communication device 223 and the equipment communication device 91 each include a communication circuit compliant with a wireless LAN standard or a wireless PAN standard, such as the Institute of Electrical and Electronic Engineers (IEEE) 802.11 series (sometimes referred to as “Wi-Fi” (“Wi-Fi” is a trademark of the Wi-Fi Alliance)), or the IEEE 802.15 series. Further, the in-vehicle communication device 223 and the equipment communication device 91 each include, in addition to such communication circuits, a communication circuit capable of wireless communication based on a communication method (communication standard) different from that of those communication circuits. For example, the in-vehicle communication device 223 and the equipment communication device 91 each include a communication circuit which uses long waves (low frequency (LF), or longwave or long wave (LW); radio waves having a frequency of from 30 kHz to 300 kHz) for communication, a communication circuit which uses radio frequencies (RF) for communication, and a communication circuit of an ultra-wideband (UWB) wireless system. Further, the in-vehicle communication device 223 and the equipment communication device 91 may each include a communication circuit compliant with a short-range wireless communication standard, such as dedicated short-range communications (DSRC) or radio frequency identifier (RFID). The in-vehicle communication device 223 and the equipment communication device 91 are configured to enable wireless communication to and from each other by each of at least two types of communication methods (communication standards) different from each other. For example, the in-vehicle communication device 223 and the equipment communication device 91 each include a plurality of communication circuits capable of wireless communication using different communication methods. Further, one of the in-vehicle communication device 223 and the equipment communication device 91 may include a tag (an information recording medium that reads and writes data in a non-contact manner by using radio waves (electromagnetic waves)), and the other may include a reader that reads out data from the tag in a non-contact manner. The in-vehicle communication device 223 performs wireless communication to and from the equipment communication device 91 under the control by the communication ECU 206. The communication ECU 206 transmits and receives various types of information to be used for a power receiving unit 224 to receive power from the wireless power supply device 90 in a non-contact manner by using the wireless communication to and from the wireless power supply device 90.

The charging ECU 207 controls the charging of the battery 11. The power receiving unit 224 is connected to the charging ECU 207. The power receiving unit 224 includes a power receiving coil 225 and a charging circuit 226. The power receiving coil 225 is configured to receive the supply of power from the power transmission coil 93 of the wireless power supply device 90 in a non-contact manner. The charging circuit 226 charges the battery 11 with the power received by the power receiving coil 225 under the control of the charging ECU 207. The power receiving coil 225 is installed on a bottom surface of a vehicle body (for example, a lower surface of a floor panel).

The HMI 208 is arranged at a place at which the driver of the vehicle 10 can see and operate the HMI 208. The HMI 208 includes a touch panel display 209 which can display images and receive touch operations. The vehicle control ECU 201 can display various images on the touch panel display 209 of the HMI 208 and can detect an operation on the touch panel display 209.

(Parking Assist Control)

Next, parking assist control to be executed by the assist apparatus 20 is described. The parking assist control is control for setting a target parking area TA in the parking space PS and assisting the parking of the vehicle 10 in the set target parking area TA. The parking assist apparatus 20 according to the at least one embodiment moves the vehicle 10 to the target parking area TA without requiring the driver to operate the accelerator pedal, the brake pedal, or the steering wheel to assist the parking of the vehicle 10 in the target parking area TA. As described above, the parking space PS is a space partitioned so that one vehicle can park. More specifically, the parking space PS is a space in which the dimension in the front-rear direction and the dimension in the width direction are larger than the dimension in the front-rear direction and the dimension in the width direction of the vehicle 10 in a top view. The target parking area TA is the area in which the vehicle 10 is to actually be parked in the parking space PS (area in which the vehicle 10 fits), and is an area having substantially the same shape and dimensions as those of the vehicle 10 in a top view.

(Detection (Recognition) of Parking Space)

The vehicle control ECU 201 searches for the parking space PS present in the peripheral region of the vehicle 10 by using the image data acquired from each of the cameras 210, 211, 212, and 213. Specifically, the vehicle control ECU 201 first extracts a plurality of feature points included in the image data acquired from each of the cameras 210, 211, 212, and 213. Each feature point is a minute region in which a change in brightness is equal to or more than a threshold value (in other words, a region in which the brightness changes abruptly). Further, the vehicle control ECU 201 acquires gradation information on areas including the detected feature points. Specifically, the vehicle control ECU 201 sets a square area having a predetermined length on each side centered on one acquired feature point as a feature area corresponding to the one feature point, and divides the set feature area into a plurality of divided areas (specifically, 25 squares arranged in a matrix of 5 rows by 5 columns). Then, the vehicle control ECU 201 acquires the brightness of each divided area, and calculates, for each divided area, a “difference from an average brightness (that is, an average value of the brightness of all the divided areas) (=(brightness of each divided area)−(average value of brightness of all divided areas)).” The vehicle control ECU 201 acquires the calculated difference as gradation information indicating a trend in the level of the brightness in each feature area. Then, the vehicle control ECU 201 stores information including the position information on each detected feature point and the gradation information on each feature area corresponding to each feature point in the non-volatile memory in association with ID information for identifying the feature point as information relating to each feature point (hereinafter referred to as “feature point information”).

Then, the vehicle control ECU 201 converts the feature point information into coordinates in a real coordinate system (coordinate system indicating a position in real space based on a predetermined position of the vehicle 10 as a reference (coordinate origin)) by applying distortion correction to the coordinates of each feature point on the image (that is, the positions of the pixels corresponding to each feature point on the image). Further, the vehicle control ECU 201 detects the parking space PS by using the feature point information included in the image. For example, the vehicle control ECU 201 detects white lines drawn on the road surface by linearly approximating rows of feature points included in the image (that is, edges included in the image), and detects the region between two detected parallel white lines as the parking space PS. As the method of detecting the parking space PS, various publicly known methods can be applied. For example, the methods as described in Japanese Patent Application Laid-open No. 2007-290558 and Japanese Patent Application Laid-open No. 2008-201178 can be applied.

(Identification of Position of Power Transmission Unit)

The communication ECU 206 continuously searches for a wireless power supply device 90 (equipment communication device 91) capable of wireless communication present in the peripheral region of the vehicle 10 by using one of a plurality of communication methods (communication standards). When a wireless power supply device 90 capable of wireless communication is detected, the communication ECU 206 establishes wireless communication to and from the equipment communication device 91 of the detected wireless power supply device 90. For convenience of description, the communication method is referred to as “first communication method.” For example, a communication method (communication standard) compliant with the IEEE 11 series is applied to the first communication method. When wireless communication based on the first communication method is established between the in-vehicle communication device 223 and the equipment communication device 91, the vehicle control ECU 201 acquires identification information transmitted from the wireless power supply device 90 (information indicating the manufacturer (manufacturing company) of the wireless power supply device 90) by wireless communication via the in-vehicle communication device 223. Then, the vehicle control ECU 201 uses the acquired identification information to search for an image of the power transmission unit 92 included in the image data acquired from each of the cameras 210, 211, 212, and 213. When an image of the power transmission unit 92 has successfully been detected by the search, the vehicle control ECU 201 identifies the position of the power transmission unit 92 in the real coordinate system based on the detection result. Specifically, the position is identified as follows.

In the vehicle control ECU 201, information relating to features of the external appearance of the power transmission unit 92 of a plurality of wireless power supply devices 90 is registered in association with the information indicating the manufacturer. In the following, the “information relating to features of the external appearance of the power transmission unit 92” is referred to as “external appearance information,” and the data including the external appearance information is referred to as “external appearance data.” Further, “the external appearance information is registered in the vehicle control ECU 201” can be described as “the external appearance data is stored in the non-volatile memory of the vehicle control ECU 201 in a computer-readable format.” To the external appearance information, position information on a plurality of feature points extracted from an image of the power transmission unit 92 (for example, information indicating a relative positional relationship among feature points), and gradation information on the areas (feature areas) including the feature points can be applied. The meaning of “gradation information on the areas including the feature points” is as described above. Further, when a certain manufacturer manufactures a plurality of types of wireless power supply devices 90 having different external appearances from each other, a plurality of pieces of external appearance information are associated with the certain manufacturer.

The vehicle control ECU 201 reads out, from a plurality of pieces of external appearance information registered in advance, the external appearance information on the power transmission unit 92 associated with the same manufacturer as the manufacturer indicated by the identification information acquired via wireless communication. Then, the vehicle control ECU 201 uses the read external appearance information to search for an image of the power transmission unit 92 included in the image data acquired from each of the cameras 210, 211, 212, and 213. Specifically, the vehicle control ECU 201 searches for the image of the power transmission unit 92 included in the image data by performing pattern matching in which the read external appearance information (external appearance data) is used as a template and the image data acquired from each of the cameras 210, 211, 212, and 213 are search images. When the vehicle control ECU 201 detects the power transmission unit 92, the vehicle control ECU 201 confirms the position of the detected power transmission unit 92 in the real coordinate system.

With such a method, various power transmission units 92 having different shapes can be detected. For example, with a method of detecting (recognizing) the power transmission unit 92 installed in the parking space based on the arrangement of the feature points (edges) included in the image data acquired from each of the cameras 210, 211, 212, and 213, the external appearance shape of the power transmission unit installed in the parking space is unknown, and hence it is not possible to identify whether or not the detected object is a power transmission unit. Even when the detected object is a power transmission unit, it is not possible to accurately identify the external appearance shape of the power transmission unit. Further, when the power transmission unit 92 is not identifiable, in some cases, the target parking area TA is not set to the “position suitable for charging” described later. In contrast, in the at least one embodiment, the power transmission unit 92 is searched for by using external appearance data registered in the vehicle control ECU 201 in advance, and hence the external appearance shape of the power transmission unit 92 can be identified, and as a result, power transmission units 92 having various external appearances can be detected. Moreover, the position of the detected power transmission unit 92 can be accurately identified.

Further, according to the at least one embodiment, it is possible to reduce the processing load on the vehicle control ECU 201. For example, with a method in which the pieces of external appearance information on the various power transmission units 92 are registered in advance in the vehicle control ECU 201, and the image of the power transmission unit 92 is searched for in an exhaustive manner by using those plurality of pieces of external appearance information, processing of “searching for the image of the power transmission unit 92 by using one piece of external appearance information” is required to be executed repeatedly for each piece of external appearance information. In contrast, according to the at least one embodiment, through use of the external appearance information associated with the manufacturer indicated by the identification information acquired by wireless communication, the power transmission unit 92 can be searched for by using only the external appearance information associated with the manufacturer, and hence it is not required to perform an exhaustive search.

The vehicle control ECU 201 is configured such that additional external information can be registered. In other words, for example, the user of the vehicle 10 can additionally store the external appearance data of the power transmission unit 92 of an unregistered wireless power supply device 90 in the readable/writable non-volatile memory of the vehicle control ECU 201. Further, when the in-vehicle communication device 223 is connected to the Internet, the vehicle control ECU 201 may access a server in which the external appearance data of the power transmission unit 92 of the wireless power supply device 90 is stored, and when the external appearance data of the power transmission unit 92 of the wireless power supply device 90 not registered in the vehicle control ECU 201 exists in the server, the vehicle control ECU 201 may download and store the external appearance data in the readable/writable non-volatile memory. In this case, it is required to prepare in advance a server in which the external appearance data of the power transmission unit 92 of the wireless power supply device 90 is stored.

(Setting of Target Parking Area)

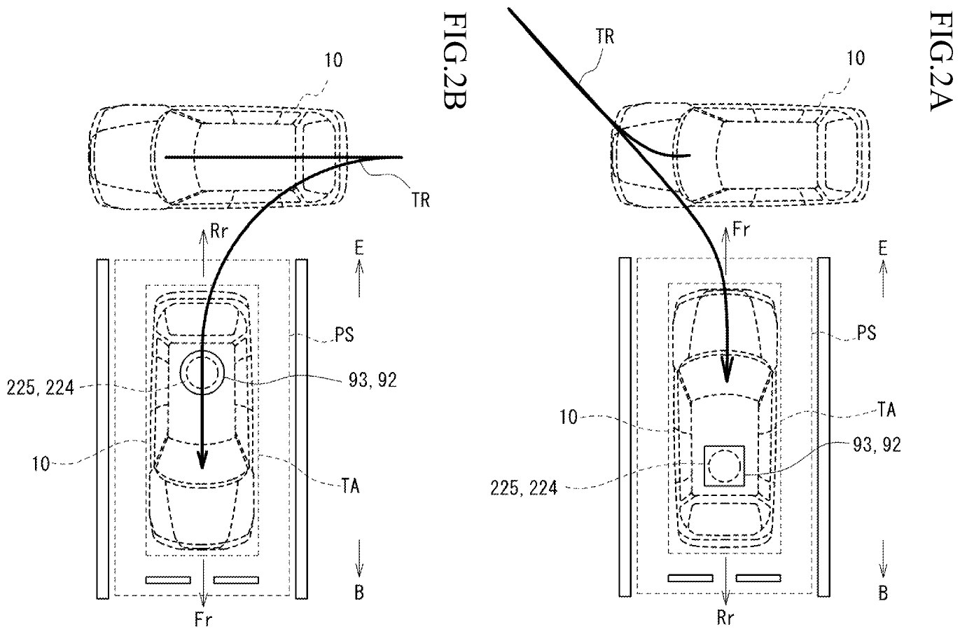

The vehicle control ECU 201 sets the target parking area TA to a “position suitable for charging” and in an “orientation which fits well in the parking space PS.” FIG. 2A and FIG. 2B are schematic diagrams for illustrating an example of the “position suitable for charging” and the “orientation which fits well in the parking space PS” of the target parking area TA. Here, the “orientation which fits well in the parking space PS” can also be referred to as an orientation suitable for parking in the parking space PS. In FIG. 2A and FIG. 2B, the front side of the vehicle 10 is indicated by an arrow Fr, the rear side of the vehicle 10 is indicated by an arrow Rr, the entrance side of the parking space PS is indicated by an arrow E, and the far side of the parking space PS is indicated by an arrow B. When wireless charging by the wireless power supply device 90 is executed, the efficiency of power transmission becomes higher as the deviation between the position of the power transmission coil 93 of the wireless power supply device 90 installed in the parking space PS and the position of the power receiving coil 225 installed in the vehicle 10 in a top view becomes smaller. Thus, in the at least one embodiment, the position at which the position of the power transmission coil 93 of the wireless power supply device 90 installed in the parking space PS and the position of the power receiving coil 225 installed in the vehicle 10 match each other in a top view (more specifically, the position at which the center of the power transmission coil 93 and the center of the power receiving coil 225 match each other in a top view) is regarded as the “position suitable for charging.”

Further, in the at least one embodiment, the orientation in which the front-rear direction of the vehicle 10 is parallel to the long direction of the parking space PS and the deviation between the center of the vehicle 10 in the front-rear direction and the center of the parking space PS in the long direction is small is regarded as the “orientation which fits well in the parking space PS.” In a case in which the power transmission coil 93 is installed at a position deviating from the center of the parking space PS in the long direction toward the entrance side or the far side, and a case in which the power receiving coil 225 is arranged at a position deviating from the center of the vehicle 10 in the front-rear direction toward the front side or the rear side, when the target parking area TA is set to the position suitable for charging, the center of the vehicle 10 in the front-rear direction and the center of the parking space PS in the long direction may deviate from each other. Thus, the vehicle control ECU 201 sets the orientation of the target parking area TA to the above-mentioned “orientation which fits well in the parking space PS.” For example, as illustrated in FIG. 2A, when the power receiving unit 224 is arranged at a position deviating from the center of the vehicle 10 toward the rear side, and the power transmission unit 92 is installed at a position deviating from the center of the parking space PS in the long direction toward the far side, the vehicle control ECU 201 sets the target parking area TA in an orientation in which the front side of the vehicle 10 is positioned at the entrance side of the parking space PS (that is, a reverse parking orientation). Meanwhile, as illustrated in FIG. 2B, when the power receiving unit 224 is arranged at a position deviating from the center of the vehicle 10 toward the rear side, and the power transmission unit 92 is installed at a position deviating from the center of the parking space PS in the long direction toward the entrance side, the vehicle control ECU 201 sets the target parking area TA in an orientation in which the front side of the vehicle 10 is positioned at the far side of the parking space PS (that is, a forward parking orientation).

In the configuration in which the power receiving coil 225 is arranged in the center of the vehicle 10 in the front-rear direction, the position suitable for charging in the target parking area TA with respect to the parking space PS is the same when the vehicle 10 faces the entrance side or the far side of the parking space PS. In order to handle such a case, in the vehicle control ECU 201, a priority for each of forward parking (parking in the orientation in which the front side of the vehicle 10 faces the far side of the parking space PS) and reverse parking (parking in the orientation in which the front side of the vehicle 10 faces the entrance side of the parking space PS) is registered in advance. When the orientation is an “orientation which fits well in the parking space PS” regardless of whether the front side of the vehicle 10 faces the far side or the entrance side of the parking space PS, the vehicle control ECU 201 sets the orientation of the target parking area TA to the orientation having a higher priority. The priority can be changed by the user of the vehicle 10, for example.

(Operation of Parking Assist Apparatus)

Next, operation of the assist apparatus 20 is described. Each of the cameras 210, 211, 212, and 213 continuously executes processing of “generating image data by photographing the landscape of the peripheral region of the vehicle 10, and transmitting the generated image data to the vehicle control ECU 201.” The vehicle control ECU 201 continuously executes processing of extracting a plurality of feature points from the image data acquired from each of the cameras 210, 211, 212, and 213.

The communication ECU 206 continuously searches for a wireless power supply device 90 (equipment communication device 91) capable of wireless communication. When the communication ECU 206 detects a wireless power supply device 90 capable of wireless communication, the communication ECU 206 establishes wireless communication based on the first communication method between the in-vehicle communication device 223 and the equipment communication device 91 of the wireless power supply device 90. When the in-vehicle communication device 223 includes a communication circuit compliant with a wireless LAN standard such as the IEEE 802.11 series, the communication ECU 206 continuously wirelessly transmits an authentication signal to the in-vehicle communication device 223. The communication ECU 206 then waits for the in-vehicle communication device 223 to receive an authentication signal transmitted by the equipment communication device 91. When the in-vehicle communication device 223 receives the authentication signal transmitted by the equipment communication device 91, the vehicle control ECU 201 causes the in-vehicle communication device 223 to transmit a connection request, and waits for a connection permission signal to be transmitted from the equipment communication device 91. When the in-vehicle communication device 223 receives the connection permission signal transmitted from the equipment communication device 91, the vehicle control ECU 201 establishes wireless communication to and from the equipment communication device 91. When wireless communication is established between the in-vehicle communication device 223 and the equipment communication device 91, the vehicle control ECU 201 acquires the identification information on the wireless power supply device 90 from the wireless power supply device 90 by wireless communication.

The vehicle control ECU 201 may execute the processing of extracting the feature points when a predetermined condition is satisfied. Similarly, the communication ECU 206 may execute the processing for establishing wireless communication between the in-vehicle communication device 223 and the equipment communication device 91 when a predetermined condition is satisfied. For example, when the vehicle speed becomes equal to or lower than a threshold value while the vehicle 10 is traveling, the vehicle control ECU 201 determines that the predetermined condition is satisfied, starts executing the processing of extracting the plurality of feature points from the image data acquired from each of the cameras 210, 211, 212, and 213, and starts searching fora wireless power supply device 90 capable of wireless communication to and from the communication ECU 206.

After the vehicle 10 stops, when the vehicle control ECU 201 detects an operation on the parking assist switch 215, the vehicle control ECU 201 searches for a parking space PS which is present in the peripheral region of the vehicle 10 based on the features extracted at that time. When the vehicle control ECU 201 has successfully detected a parking space PS, the vehicle control ECU 201 identifies the position of the parking space PS in the real coordinate system. Further, when the vehicle control ECU 201 has detected the wireless power supply device 90 by the search, the vehicle control ECU 201 establishes wireless communication between the in-vehicle communication device 223 and the equipment communication device 91 of the wireless power supply device 90 as described above, and acquires the identification information from the wireless power supply device 90 via wireless communication. Moreover, the vehicle control ECU 201 reads out the external appearance information associated with the manufacturer indicated by the acquired identification information, and then uses the read external appearance information to search for the power transmission unit 92 installed in the parking space PS and identify the position of the power transmission unit 92 detected by the search. Then, the vehicle control ECU 201 sets the target parking area TA to the “position suitable for charging” and in the “orientation which fits well in the parking space PS” based on the identified position of the parking space PS and position of the power transmission unit 92.

Further, the vehicle control ECU 201 displays a setting image on the touch panel display 209 of the HMI 208. The setting image includes a plan view image, a target parking area image, a movement button image, and a confirmation button image. The plan view image is an image of the region in which the vehicle 10 is present and the peripheral region of the vehicle 10, and is an image of the landscape of the area including the detected parking space PS as seen from directly above. The vehicle control ECU 201 generates the plan view image from the image data acquired from each of the cameras 210, 211, 212, and 213. The target parking area image is a quadrangular frame-shaped image showing the target parking area TA, and is an image superimposed and displayed on the plan view image. The movement button image is an image operated by the user in order to move the target parking area image. When a touch operation on the movement button image is detected, the vehicle control ECU 201 moves the target parking area image on the plan view image in accordance with the touch operation.

The confirmation button image is an image operated by the user in order to set (confirm) the position of the target parking area image in the plan view image as the target parking area TA. When the vehicle control ECU 201 detects a touch operation on the confirmation button image while the setting image is displayed, the vehicle control ECU 201 confirms the position and orientation of the target parking area image displayed in the parking space PS on the plan view image as the actual position and orientation of the target parking area TA with respect to the parking space PS. Further, when the vehicle control ECU 201 confirms the position and orientation of the target parking area TA, the vehicle control ECU 201 sets a target travel route TR along which the vehicle 10 is to travel in order to park the vehicle 10 in the target parking area TA. The method of setting the target travel route TR is not limited, and a publicly known method can be applied.

When confirmation of the target parking area TA and confirmation of the target travel route TR are complete, the vehicle control ECU 201 waits for an operation by the user to instruct movement of the vehicle 10 to be started. For example, the vehicle control ECU 201 displays a parking start button image on the touch panel display 209 of the HMI 208. Then, when the vehicle control ECU 201 detects a touch operation on the parking start button image, the vehicle control ECU 201 starts the parking travel processing. The parking travel processing is processing of causing the vehicle 10 to travel along the set target travel route TR to the target parking area TA based on, for example, information relating to three-dimensional objects present around the vehicle 10 detected by the sonar sensor 214, images of the peripheral regions of the vehicle 10 taken by each of the cameras 210, 211, 212, and 213, and the vehicle speed acquired from the vehicle speed sensor (not shown). The vehicle control ECU 201 transmits a drive command to the PM ECU 202, a steering command to the EPS ECU 203, and a braking command to the brake ECU 205 so that the vehicle 10 travels along the target travel route TR to the target parking area TA.

The communication ECU 206 uses, during the execution of the parking travel processing, another communication method different from the first communication method (the another communication method is hereinafter referred to as “second communication method”) to establish wireless communication between the in-vehicle communication device 223 and the wireless power supply device 90 (equipment communication device 91). As described above, when the first communication method is a communication method based on the IEEE 802.11 series, for example, a communication method compliant with a wireless LAN standard such as the IEEE 802.15 series, a communication method using long waves (LF) for communication, or a communication method of an ultra-wideband wireless system is applied to the second communication method. As the second communication method, it is preferred to apply a method having a shorter wireless communication distance than that of the first communication method. For example, when the first communication method is a communication method based on the IEEE 802.15 series, a communication method compliant with a wireless PAN standard such as the IEEE 802.15 series can be applied to the second communication method. In this case, the second communication method may be a communication method based on the wireless LAN standard, a DSRC method, or an RFID method. When the entire vehicle 10 has fit in the target parking area TA, the vehicle control ECU 201 stops the vehicle 10 and ends the parking travel processing. As a result, the parking of the vehicle 10 in the target parking area TA is complete.

When the parking is complete, the vehicle control ECU 201 transmits a signal instructing charging to be started to the communication ECU 206 by wireless communication based on the second communication method. When the communication ECU 206 receives the signal instructing charging to be started from the vehicle control ECU 201, the communication ECU 206 causes the in-vehicle communication device 223 to transmit a “signal instructing charging to be started” to the equipment communication device 91 by wireless communication based on the second communication method. When the equipment communication device 91 receives the signal, the wireless power supply device 90 starts power transmission. As a result, the power receiving unit 224 receives power. The power received by the power receiving unit 224 is charged in the battery 11.

After that, the vehicle control ECU 201 continuously acquires information indicating a charging rate of the battery 11 from the charging ECU 207, and continuously determines whether or not the charging rate of the battery 11 becomes equal to or higher than a predetermined threshold value. When the charging rate of the battery 11 becomes equal to or higher than the predetermined threshold value, the vehicle control ECU 201 transmits a signal instructing charging to be ended to the communication ECU 206. When the communication ECU 206 receives the signal instructing charging to be ended from the vehicle control ECU 201, the communication ECU 206 causes the in-vehicle communication device 223 to transmit a “signal instructing charging to be ended” to the equipment communication device 91 by wireless communication. When the equipment communication device 91 receives the signal, the wireless power supply device 90 stops (ends) power transmission. As a result, charging of the battery 11 ends. The wireless power supply device 90 may acquire information indicating the charging rate of the battery 11 of the vehicle 10 by wireless communication, and stop power transmission based on the acquired information indicating the charging rate.

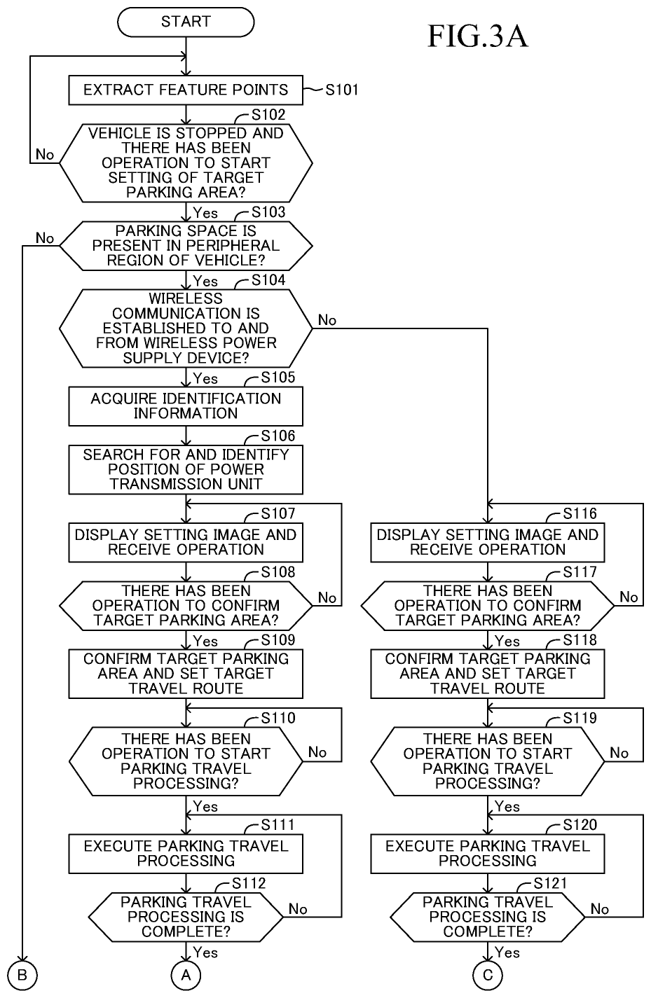

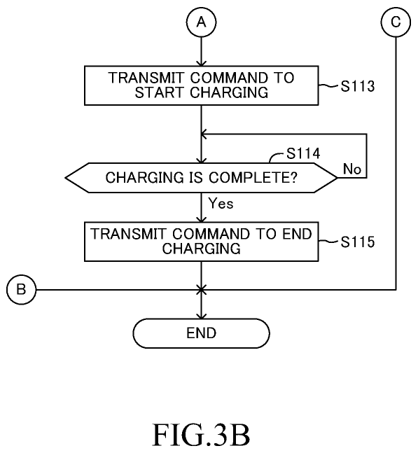

Next, a parking assist routine to be executed by the CPU of the vehicle control ECU 201 is described with reference to FIG. 3A and FIG. 3B. FIG. 3A and FIG. 3B are flow charts for illustrating a parking assist routine to be executed by the CPU of the vehicle control ECU 201. The routine is executed when a predetermined condition is satisfied, for example, when the vehicle speed is equal to or lower than a predetermined vehicle speed. In the following description, the CPU of the vehicle control ECU 201 is simply referred to as “CPU.” In the readable/writable non-volatile memory of the vehicle control ECU 201, the external appearance data of the power transmission unit 92 of each of a plurality of wireless power supply devices 90 is stored in advance in association with information indicating the manufacturer of the wireless power supply device 90. Each of the cameras 210, 211, 212, and 213 continuously executes processing of “generating image data by photographing the landscape of the peripheral region of the vehicle 10, and transmitting the generated image data to the vehicle control ECU 201.” Further, during the period in which wireless communication based on the first communication method is not established between the in-vehicle communication device 223 and the equipment communication device 91, the communication ECU 206 continues to search for a wireless power supply device 90 capable of wireless communication. When the communication ECU 206 detects a wireless power supply device 90 capable of wireless communication, the communication ECU 206 establishes wireless communication based on the first communication method to and from the wireless power supply device 90 (equipment communication device 91).

In Step S101, the CPU acquires image data from each of the cameras 210, 211, 212, and 213, extracts a plurality of feature points from the acquired image data, and stores feature point information on the extracted feature points in the RAM in association with ID information for identifying each feature point. Then, the CPU advances the process to Step S102.

In Step S102, the CPU determines whether or not the vehicle 10 is stopped and there has been an operation to start the setting of the target parking area TA. In the at least one embodiment, the CPU determines that there has been an operation to start the setting of the target parking area TA when there has been an operation on the parking assist switch 215. When the vehicle 10 is stopped and there has been an operation to start the setting of the target parking area TA, the CPU advances the process to Step S103. When the vehicle 10 is not stopped, and when there has not been an operation to start the setting of the target parking area TA, the CPU returns the process to Step S101.

In Step S103, the CPU uses the feature point information on the extracted feature points to search for a parking space PS present in the peripheral region of the vehicle 10 in which the vehicle 10 can park. When a parking space PS present in the peripheral region of the vehicle 10 in which the vehicle 10 can park has successfully been detected (in other words, when the parking space PS is present), the CPU advances the process to Step S104. When a parking space PS present in the peripheral region of the vehicle 10 in which the vehicle 10 can park has failed to be detected, the CPU ends this parking assist routine.

In Step S104, the CPU determines whether or not wireless communication based on the first communication method is established between the equipment communication device 91 of the wireless power supply device 90 installed in the parking space PS and the in-vehicle communication device 223. When wireless communication based on the first communication method is established between the in-vehicle communication device 223 and the equipment communication device 91, the CPU advances the process to Step S105. Meanwhile, when wireless communication based on the first communication method is not established between the in-vehicle communication device 223 and the equipment communication device 91, the CPU advances the process to Step S116.

In Step S105, the CPU acquires, from the wireless power supply device 90 to which wireless communication has been established, the identification information on the wireless power supply device 90 by wireless communication based on the first communication method via the in-vehicle communication device 223. Then, the CPU advances the process to Step S106.

In Step S106, the CPU uses the information indicating the manufacturer of the wireless power supply device 90 represented by the identification information acquired in Step S105 and the feature point information extracted in Step S101 to search for the power transmission unit 92 installed in the parking space PS by, for example, pattern matching, and when the power transmission unit 92 has successfully been detected, identifies the position of the power transmission unit 92. Specifically, first, the CPU reads out the feature data associated with the manufacturer indicated by the identification information acquired in Step S104 from the non-volatile memory. Then, the CPU searches for the power transmission unit 92 by using the read feature data and the feature point information on the feature points of the image data stored in the RAM. When the power transmission unit 92 has successfully been detected, the CPU identifies the position of the power transmission unit 92 in the real coordinate system.

When the power transmission unit 92 has not successfully been detected by the above-mentioned processing, the CPU estimates the position of the power transmission unit 92 by using the feature point information on the feature points stored in the RAM. For example, when the CPU searches for a “region surrounded by feature points (region surrounded by edges)” present inside the parking space PS, and the CPU has successfully detected a “region surrounded by feature points,” the CPU estimates that the region is the power transmission unit 92. Then, the CPU identifies the position of the estimated power transmission unit 92 in the real coordinate system.

Then, the CPU uses the identified position of the power transmission unit 92 in the real coordinate system (position with respect to the parking space PS) to set the target parking area TA to the “position suitable for charging” and in the “orientation which fits well in the parking space PS.” Then, the CPU advances the process to Step S107.

In Step S107, the CPU displays the setting image on the touch panel display 209 of the HMI 208. As described above, the setting image includes a plan view image including the detected parking space PS and a target parking area image superimposed and displayed on the plan view image. The position and orientation of the target parking area image on the plan view image are the “position suitable for charging” and the “orientation which fits well in the parking space PS” set in Step S106. The CPU may superimpose and display a figure indicating the power transmission unit 92 identified in Step S106 on the corresponding position on the plan view image. Further, the power receiving unit 224 in a case in which the vehicle 10 is parked in the target parking area TA may be superimposed and displayed on the corresponding position on the plan view image.

Further, in Step S107, the CPU displays the movement button image and the confirmation button image on the setting image, and receives operations of those button images. Then, the CPU advances the process to Step S108.

In Step S108, the CPU determines whether or not there has been an operation to confirm the position and orientation of the target parking area TA. For example, when the CPU detects a touch operation on the confirmation button image displayed on the setting image, the CPU determines that there has been an operation to confirm the position and orientation of the target parking area TA. The CPU repeatedly executes the processing steps of Step S107 and Step S108 until there is an operation to confirm the position and orientation of the target parking area TA. Further, the CPU receives touch operations on the movement button image displayed on the setting image until there is an operation to confirm the target parking area TA. When the CPU detects a touch operation on the movement button image, the CPU moves the target parking area image superimposed and displayed on the plan view image in accordance with the touch operation on the movement button image. When the CPU detects an operation to confirm the position and orientation of the target parking area TA, the CPU advances the process to Step S109.

In Step S109, the CPU confirms the “position and orientation of the target parking area image on the plan view image” at the time at which the “operation to confirm the position and orientation of the target parking area TA” is detected in Step S108 as the position and orientation of the target parking area TA in the actual parking space PS. Then, the CPU sets the target travel route TR along which the vehicle 10 is to travel in order to park the vehicle 10 in the target parking area TA. Further, the CPU displays the parking start button image on the touch panel display 209 of the HMI 208. Then, the CPU advances the process to Step S110.

In Step S110, the CPU determines whether or not there has been an operation to instruct the parking travel processing to be started. When an operation to instruct the parking travel processing to be started is detected, the CPU advances the process to Step S111. For example, when the CPU detects a touch operation on the parking start button image, the CPU determines that there has been an operation to instruct the parking travel processing to be started. When there has not been an operation to instruct the parking travel processing to be started, the CPU causes the process to wait at this step, and when the operation is performed, advances the process to Step S111.

In Step S111, the CPU executes the parking travel processing. Further, after execution of the parking travel processing is started, the CPU transmits a command to establish wireless communication based on the second communication method between the in-vehicle communication device 223 and the equipment communication device 91 to the communication ECU 206. When the communication ECU 206 receives the command, the communication ECU 206 establishes wireless communication based on the second communication method between the in-vehicle communication device 223 and the equipment communication device 91. Then, the CPU advances the process to Step S112. In Step S112, the CPU determines whether or not the parking travel processing is complete, specifically, whether or not the vehicle 10 has reached the target parking position and stopped. When the parking travel processing is not complete, the CPU continues to execute the parking travel processing until the vehicle 10 reaches the target parking position and stops. When the parking travel processing is complete, the CPU advances the process to Step S113.

In Step S113, the CPU transmits a signal instructing charging to be started to the communication ECU 206. When the communication ECU 206 receives the signal instructing charging to be started from the vehicle control ECU 201, the communication ECU 206 causes the in-vehicle communication device 223 to transmit the “signal instructing charging to be started” to the equipment communication device 91 by wireless communication based on the second communication method. As a result, power transmission by the wireless power supply device 90 is started. The power transmitted from the wireless power supply device 90 is received by the power receiving unit 224, and the power received by the power receiving unit 224 is charged in the battery 11. Then, the CPU advances the process to Step S114.

In Step S114, the CPU determines whether or not charging is complete. Specifically, the CPU continuously acquires information indicating the charging rate of the battery 11 from the charging ECU 207, and determines whether or not the charging rate of the battery 11 becomes equal to or higher than a predetermined threshold value. When the charging rate of the battery 11 becomes equal to or higher than the predetermined threshold value, the CPU determines that the charging is complete. The CPU causes the process to wait at this step until the charging of the battery 11 is complete, and when the charging is complete, advances the process to Step S115.

In Step S115, the CPU transmits a signal instructing charging to be ended to the communication ECU 206. When the communication ECU 206 receives the signal instructing charging to be ended from the vehicle control ECU 201, the communication ECU 206 causes the in-vehicle communication device 223 to transmit the “signal instructing charging to be ended” to the equipment communication device 91 by wireless communication. As a result, power transmission by the wireless power supply device 90 is stopped (ended). The wireless power supply device 90 may acquire information indicating the charging rate of the battery 11 of the vehicle 10 by wireless communication, and stop power transmission based on the acquired information indicating the charging rate. In this case, the processing steps of Step S114 and Step S115 are not required.

When wireless communication to and from the wireless power supply device 90 has failed to be established in Step S104, the CPU advances the process to Step S116. In this case, a power transmission unit 92 of the wireless power supply device 90 is not installed in the parking space PS. Then, the processing step of each of Step S116, Step S117, Step S118, Step S119, Step S120, and Step S121 is executed. The processing contents of those steps are the same as the processing contents of the steps of Step S107, Step S108, Step S109, Step S110, Step S111, and Step S112, respectively, and hence description thereof is omitted here. However, the position and orientation of the target parking area image on the plan view image included in the set image in Step S116 are a position (for example, the center position of the parking space PS) and an orientation (for example, an orientation having a higher priority) determined in advance.

With the parking assist routine described above, power transmission units 92 having different external appearances can be detected by using the external appearance information corresponding to the identification information acquired from the wireless power supply device 90. Therefore, regardless of the external appearance of the power transmission unit 92 installed in the parking space PS, the vehicle 10 can be automatically parked in the position suitable for charging and in the orientation which fits well in the parking space PS.

Description has been given of the at least one embodiment of the present invention, but the present invention is not limited to the at least one embodiment described above. The present invention may adopt various modification examples without departing from the spirit of the present invention.

For example, in the at least one embodiment described above, there has been described the configuration in which the power receiving unit 224 includes the power receiving coil 225 and can receive the transmission of power from the power transmission unit 92 of the wireless power supply device 90 in a non-contact manner. However, the power receiving unit 224 is not limited to such a configuration. Specifically, the power receiving unit 224 may have a configuration capable of receiving the transmission of power by contacting the power receiving unit 224 with a power transmission unit of a contact-type power supply device. For example, there has been known a contact-type power supply device including a power transmission unit configured to contact the power receiving unit 224 arranged in the vehicle 10 by ascending. The power receiving unit 224 of the parking assist apparatus 20 according to the at least one embodiment of the present invention may be configured to be able to receive the transmission of power by contacting the power transmission unit of such a contact-type power supply device. In order for the power transmission unit of a contact-type power supply device to contact the power receiving unit 224 installed in the vehicle 10 so as to be able to transmit power, the power receiving unit 224 installed in the vehicle 10 and the power transmission unit installed in the parking space PS are required to be aligned. According to the at least one embodiment of the present invention, various types of power transmission units having different external appearances can be detected, and hence the target parking area TA can be set in a position suitable for charging regardless of the external appearance of the power transmission unit installed in the parking space PS.

Further, in the at least one embodiment described above, as the parking assist control, control of parking the vehicle 10 in the target parking area TA without requiring the driver to operate the accelerator pedal, the brake pedal, or the steering wheel has been described. However, the parking assist control is not limited to such control. For example, the parking assist control may be control performed by controlling the steering angle of the steered wheels of the vehicle 10 so that the vehicle 10 travels along the target travel route TR and causing the vehicle 10 to travel in accordance with the operation of the accelerator pedal and the shift operation by the user. In short, the parking assist control may be any control of assisting the parking of the vehicle 10 in the target parking area TA.

Further, in the at least one embodiment described above, there has been described the configuration in which the in-vehicle communication device 223 and the equipment communication device 91 can wirelessly communicate to and from each other based on the first communication method and the second communication method which are different from each other, and the in-vehicle communication device 223 acquires identification information from the wireless power supply device 90 by wireless communication based on the first communication method and transmits a signal instructing charging to be started or charging to be ended to the wireless power supply device 90 by wireless communication based on the second communication method. However, the present invention is not limited to such a configuration. For example, the communication method for wireless communication to be used when the in-vehicle communication device 223 acquires the identification information from the equipment communication device 91 may be the same communication method as the communication method for wireless communication to be used when the in-vehicle communication device 223 transmits a signal instructing charging to be started or charging to be ended to the equipment communication device 91. The specific methods of the first communication method and the second communication method are not particularly limited, and related-art publicly known communication methods (communication standards) can be applied.

Further, the “information relating to the features of the external appearance” is not limited to feature point information. For example, the “information relating to the features of the external appearance” may be an image (image data) of the power transmission unit 92. In this case, the image of the power transmission unit 92 included in the plan view image can be detected by using the image data as the template image and the plan view image as the search image.

Moreover, related-art publicly known methods and processing can be applied to the method of setting the target travel route TR and the parking travel processing. Similarly, a related-art publicly known method can be applied to the method of identifying the position in the real coordinate system from the position of the image of the power transmission unit 92 included in the image data acquired from each of the cameras 210, 211, 212, and 213 (in other words, the coordinate conversion method).

What is claimed is:

1. A parking assist apparatus,
the parking assist apparatus being mounted on a vehicle including a power receiving unit configured to receive power from a power supply device including a power transmission unit,
the parking assist apparatus being configured to execute parking assist for parking the vehicle in a parking space,
the parking assist apparatus comprising:
a wireless communication device configured to perform wireless communication to and from the power supply device;
an image pickup device configured to photograph a peripheral region of the vehicle; and
a control device configured to search for a parking space present in the peripheral region of the vehicle from an image of the peripheral region of the vehicle taken by the image pickup device, set a target parking area in the parking space detected by the search, and assist parking of the vehicle in the target parking area,
the control device having external appearance information, which is information relating to a feature of an external appearance of each of a plurality of the power transmission units, registered therein in association with identification information on the power supply device,
the control device being configured to, when the control device sets the target parking area in the detected parking space:
acquire the identification information from the power supply device installed in the parking space via the wireless communication device;
search for the power transmission unit included in the image of the peripheral region of the vehicle by using the external appearance information corresponding to the acquired identification information;
identify a position of the power transmission unit detected by the search; and
set a position of the target parking area so that a position of the power receiving unit matches the position of the power transmission unit in a top view.

2. The parking assist apparatus according to claim 1, wherein the identification information is information indicating a manufacturer of the power supply device.

3. The parking assist apparatus according to claim 1, wherein the power receiving unit includes a power receiving coil configured to receive transmission of power in a non-contact manner from the power transmission unit including a power transmission coil.
